(19) United States
(12) Patent Application Publication
(10) Pub. No.: US 2026/0266121 A1
(43) Pub. Date: Sep. 10, 2026

(54) Method for controlling an openable panel of a motor vehicle by detecting a movement of a target

(71) Applicant: SCHAEFFLER TECHNOLOGIES AG & CO. KG, Herzogenaurach (DE)

(72) Inventors: Ihssen MASRI, ANGOULEME (FR); Cyril ROBIN, GOYRANS (FR)

(73) Assignee: SCHAEFFLER TECHNOLOGIES AG & CO. KG, Herzogenaurach (DE)

(21) Appl. No.: 19/489,298

(22) PCT Filed: May 29, 2024
(86) PCT No.: PCT/EP2024/064698

§ 371 Date: Dec. 2, 2025

(30) Foreign Application Priority Data
Jun. 5, 2023 (FR) FR2305585

(51) Int. Cl. E05F 15/73

(52) U.S. Cl. CPC E05F 15/73; E05Y 2400/36; E05Y 2400/664; E05Y 2400/86; E05Y 2900/548

(57) ABSTRACT

A method for controlling an opening of a motor vehicle by detecting movement of a target, such as user's hand or foot. The opening moveable by an actuator able to control its opening speed, and/or its degree of opening between a fully open, a fully closed, and at least one partially open intermediate position. The method including: transmitting a radiofrequency signal to at least partially reflect on the target; receiving a return signal originating from the reflection of the transmitted signal on the target; determining, based on the transmitted and return signals, at least one of movement speed, linear amplitude of movement, and/or angular amplitude of movement, relating to movement of the target relative to a determined zone of the vehicle; controlling the degree of opening and/or opening speed of the opening, using the actuator, as a function of the characteristic relating to the movement of the target.

### CROSS REFERENCE TO RELATED APPLICATIONS

This application is the U.S. National Phase Application of PCT International Application No. PCT/EP2024/064698, filed May 29, 2024, which claims priority to French Patent Application No. FR2305585, filed Jun. 5, 2023, the contents of such applications being incorporated by reference herein.

### FIELD OF THE INVENTION

The present disclosure relates to a method for controlling an opening of a motor vehicle by detecting a movement of a target, such as a hand or a foot of a user.

The present disclosure relates to the field of managing access to a motor vehicle.

### BACKGROUND OF THE INVENTION

The use of radiofrequency signals for controlling the opening of an opening of a motor vehicle, for example, a door of a trunk, is known. A radiofrequency signal is an electromagnetic signal comprising a carrier with a frequency ranging, for example, between 3 kHz and 300 GHz, but most often between 5 and 30 GHz in applications in the world of motor vehicles.

In particular, methods exist for detecting a gesture used for controlling an opening of a vehicle. In such a method, a radiofrequency signal is transmitted toward a target and the analysis of a return radiofrequency signal allows a predetermined gesture performed by a foot of a user to be recognized.

It is also known for a pulse-type radiofrequency signal (as opposed to a continuous signal) to be used with pulses referred to as radiofrequency pulses, i.e., whose carrier frequency belongs to a wide radiofrequency spectrum. The use of this type of signal notably allows a distance to be determined between a target and a device for transmitting and receiving said pulse-type radiofrequency signal.

The detection of a gesture in the considered zone controls the complete opening or closing of the opening. An aim of an aspect of the present invention is to propose a method and a device providing an improved user experience.

### SUMMARY OF THE INVENTION

To this end, the present document relates to a method for controlling an opening of a motor vehicle by detecting a movement of a target, such as a hand or a foot of a user, said opening being able to be moved by means of an actuator so as to be able to control its opening speed, and/or its degree of opening between a fully open position, a fully closed position and at least one partially open intermediate position, said method comprising the steps of:
(a) transmitting, using at least one transmitter, a radiofrequency signal, called transmitted signal, intended to at least partially reflect on said target;
(b) receiving, using at least one receiver, a radiofrequency signal, called return signal, originating from the reflection of the transmitted signal on said target;
(c) determining, based on the transmitted signal and the return signal, at least one characteristic from among a movement speed, a linear amplitude of movement, and/or an angular amplitude of movement, relating to a movement of the target relative to a determined zone of the vehicle;
(d) controlling the degree of opening and/or the opening speed of the opening, using the actuator, and as a function of said characteristic relating to the movement of the target.

The opening can be an opening able to pivot about at least one axis of rotation. In this case, the degree of opening depends on the angle of the opening relative to the fully closed position of the opening. The greater this angle, the greater the degree of opening. This can be referred to as the angular degree of opening.

Alternatively, the opening may be able to slide or translate along an axis. In this case, the degree of opening depends on the distance of the opening relative to the fully closed position. The greater this distance, the higher the degree of opening. This can be referred to as the linear degree of opening.

Said actuator can be a motor or a cylinder, which can be, for example, electrical, hydraulic or pneumatic.

Such a method thus allows the degree of opening and/or the opening speed to be controlled by simply moving the target relative to the vehicle.

In this way, a large amplitude gesture can allow, for example, significant movement of the opening, while a low amplitude gesture can allow, for example, limited movement of the opening. In other words, a large amplitude gesture can allow, for example, the opening to move from a closed position to a position exhibiting a large degree of opening or to a fully open position, or vice versa, while a low amplitude gesture can allow, for example, the opening to move from a closed position to a position exhibiting a low degree of opening, or vice versa.

Similarly, a rapid gesture can allow, for example, rapid movement of the opening, while a slow gesture can allow, for example, slow movement of the opening.

The degree of opening of the opening can be controlled discretely or continuously. In other words, a limited amount of different degrees of opening can be controlled using a gesture, or an infinite number of positions and degrees of opening of the opening can be controlled using a gesture. Similarly, the opening speed of the opening can be controlled discretely or continuously. In other words, a limited amount of different speeds can be controlled using a gesture, or an infinite number of speed values can be controlled using a gesture.

Of course, the movement of the opening can be controlled in the opening direction or in the closing direction. The direction of movement of the opening can be dependent on the direction of movement of the target, or on its trajectory, for example.

The linear amplitude of movement of the target is the measurement of the total distance covered by the target when it moves from its starting position to its final position. The linear amplitude of movement is then expressed in units of length. The angular amplitude of movement of the target is the measurement of the total angle covered by the target when it moves from its starting position to its final position. The angular amplitude of movement is then expressed in angle units. The angle can be a planar angle, i.e., a two-dimensional angle, or a solid angle, i.e., a three-dimensional angle.

The transmitter and the receiver can be located in the same transmission and reception device. The transmitter and the receiver can be formed by an antenna.

Several transmitters and several associated receivers also can be used, the transmitters (and the associated receivers) can be located in zones of the vehicle that are spaced apart from each other.

The transmitted signal can be a pulse signal comprising a carrier modulated by a sequence of pulses.

The transmitted signal is a radiofrequency signal. A radiofrequency signal denotes an electromagnetic frequency signal whose carrier frequency ranges between 3 kHz and 300 GHz. The carrier frequency, in the present document, can range between 5 GHz and 30 GHz, for example, between 5 GHz and 10 GHz.

The signal can be an ultra-wide band signal.

An Ultra-Wide Band (UWB) signal is an electromagnetic signal that is characterized by very short pulses over time (for example, of the order of a few nanoseconds) and a very wide bandwidth (for example, greater than 500 MHz, or even more than 1 GHz). The pulses are so short that their duration is of the order of a few periods of the carrier frequency, which means that the signal can have a bandwidth that is considerably wider than conventional signals. The transmitted energy of a UWB signal is also very low. This type of signal is suitable for use in environments with significant radio noise or interference.

Examples of signal processing are described hereafter that allow the movement of the target to be characterized, notably when the transmitted signal is a pulse signal comprising a carrier modulated by a sequence of pulses. These examples of data processing are indicated by way of an example, and are by no means limiting.

With a pulse-type transmitted signal, step (c) can comprise the following sub-steps of:
(c1) determining an approximate distance to the target, implementing measurement of a time shift between a pulse of the return pulse signal and the corresponding pulse of the transmitted signal;
(c2) determining an additional distance to the target, implementing monitoring of phase shift values between the return pulse signal and the transmitted pulse signal;
(c3) optionally, combining the approximate distance to the target and the additional distance to the target, so as to obtain an estimated value of the distance to the target; and
(c4) repeating said sub-steps (c1) to (c2) and optionally (c3), so as to obtain a time series of phase shift values or of estimated values of the distance to the target, with said time series of values defining a gesture, or movement of the target.

Said time series of values defining the gesture can notably allow a movement speed and/or a linear amplitude to be computed relative to the trajectory of the target during such a gesture.

Sub-step (c1) implements the measurement of a time of flight, i.e., the measurement of a time taken by a pulse to complete the round trip between the transmitter, the target and the receiver. The time of flight is related to the distance covered by the pulse by c, which is the speed of light in a vacuum. The time of flight thus allows the distance to be determined between the target and the transmitter or the receiver.

In practice, the pulses of the return radiofrequency signal are detected on an amplitude signal that is temporally sampled by an analog-to-digital converter. The frequency of the temporal sampling defines sampling time windows, and therefore the precision for the measurement of the time of flight. In order to maximize this precision, the sampling frequency must be as high as possible.

Sub-step (c1) thus allows the value of an approximate distance to the target to be obtained, with a resolution Δd1=c/(2*fe), with c being the speed of light in a vacuum, and fe being the sampling frequency of the envelope of the transmitted pulse signal. The sampling frequency of the envelope of the transmitted pulse signal is, for example, approximately 1 GHz, that is, a resolution of 15 cm on the value of the approximate distance to the target.

The use of the additional distance to the target during step (c2) then allows the margin of error to be reduced to a few millimeters.

Indeed, sub-step (c2) uses monitoring of phase shift values between the return pulse signal and the transmitted pulse signal. Each phase shift value relates to the difference between the phase of a pulse of the return signal, upon reception by the receiver, and the phase of the corresponding pulse of the transmitted signal, as transmitted by the transmitter.

The value of the phase shift between the return pulse signal and the transmitted pulse signal varies by 2π, for each variation of λ on the round-trip distance covered by the pulse, where λ is the wavelength of the pulses of the transmitted pulse signal.

Thus, each increment of 2π on the value of this phase shift corresponds to a variation of λ/2 on the outward distance between the transmitter and the target.

By counting the increments of 2π on said phase shift value, variations of λ/2 on the distance to the target are therefore counted. The result of the count of these variations defines the value of the additional distance to the target. If applicable, a yet more precise value of the additional distance to the target can be obtained, using an exact phase shift value and the remainder once the several increments of 2π have been subtracted. By counting the increments of 2π on said value of the phase shift, the additional distance to the target therefore has a resolution Δd2 defined by: Δd2=λ/2=c/(2*f), where c is the speed of light in a vacuum, and f is the frequency of the carrier of the transmitted signal.

The frequency f of the carrier of the transmitted pulse signal is greater than the sampling frequency fe of the envelope of the pulses, with, for example, a ratio of approximately 7 between the two. Consequently, the resolution in determining the additional distance to the target is lower than the resolution in determining the approximate distance to the target, with, for example, a ratio of 7 between the two, that is, a resolution of the order of 2 cm.

By using the value of the phase shift, the resolution is even better. The resolution depends on the resolution of the measurements, in practice it is much less than one millimeter.

The additional distance to the target offers a reduced margin of error.

In sub-step (c3), the additional distance to the target is combined with the approximate distance, so as to obtain an estimated value of the distance to the target. Preferably, said combination is a sum. The advantages associated with each of these two values are thus combined, namely, a known origin, by virtue of the approximate distance to the target, and a reduced margin of error, by virtue of the additional distance to the target. Said known origin corresponds to the location of the transmitter and of the receiver. Repeating steps (c1) to (c3) allows a series of estimated values of the distance to the target to be obtained, defining a movement performed by the target.

In an advantageous variant, step (c) does not comprise step (c1) or step (c3), and comprises step (c2), as well as a step of repeating step (c2) in order to obtain a time series of estimated values of variations in the distance to the target, with said time series defining a gesture. In other words, distance values to the target relative to the vehicle do not necessarily need to be computed, since the useful information relates to a movement. Sub-step (c2) can comprise the following sub-steps of:
(c21) generating a signal I(t) relating to an in-phase component of the return signal, by in-phase mixing between the return signal and an in-phase signal and at the frequency of the transmitted signal, and a signal Q(t) relating to a quadrature-phase component of the return signal, by quadrature-phase mixing between the return signal and a quadrature-phase signal and at the frequency of the transmitted signal, with the signals I(t) and Q(t) defining the two components of a demodulated return signal;
(c22) obtaining sampled data I(tᵢ) and Q(tᵢ) corresponding to temporal sampling of the signals I(t) and Q(t);
(c23) extracting, in the sampled data I(tᵢ) and Q(tᵢ), any data only relating to portions of the return signal, for which a time difference between the reception of each portion of the return signal and the emission of a corresponding pulse of the transmitted signal is less than or equal to a threshold;
(c24) computing, for each sampling instant tᵢ, a modulus of the extracted data I(tᵢ) and Q(tᵢ), denoted |CIR(tᵢ)|, corresponding to the amplitude of the demodulated return signal, and having a value equal to the square root of I²(tᵢ)+Q²(tᵢ);
(c25) searching, in the computed data |CIR(tᵢ)|, and successively for each pulse of the transmitted signal, for the presence of a peak with an amplitude that is greater than or equal to a predetermined threshold, with the first detection of such a peak corresponding to the identification of the beginning of a movement of the target (5), the instant tj associated with such a peak being recorded and a pulse of index k of the transmitted signal being associated with the first detection of such a peak;
(c26) computing the phase φ(k) of the demodulated return signal using the values I and Q associated with said instant tj of the peak, using the following formulae:

$$if I ( tj ) > 0 , then φ ( k ) = arctan ( Q ( tj ) / I ( tj ) ) ; \\ if I ( tj ) < 0 and if Q ( tj ) < 0 , then φ ( k ) = arctan ( Q ( tj ) / I ( tj ) ) - π ; \\ if I ( tj ) < 0 and if Q ( tj ) > 0 , then φ ( k ) = arctan ( Q ( tj ) / I ( tj ) ) + π ;$$

(c27) computing the evolution of the value of the phase φ, for the subsequent k+n pulses of the transmitted signal.

Sub-step (c22) can be implemented using an analog-to-digital converter. This temporal sampling can be implemented downstream of the generation of the signals I(t) and Q(t). The sampling pitch can range between 0.8 ns and 2 ns, for example, can be equal to 1 ns.

Said method can comprise an optional step of constructing matrices, occurring, for example, between sub-steps (c22) and (c23).

In this sub-step, the sampled data I(tᵢ) and Q(tᵢ) can be rows in the form of matrices. A first axis of the matrix, denoted “CIR index”, can correspond to a pulse index of the transmitted signal. A second axis of the matrix can correspond to an index, denoted “tap num”, of a sampling instant. The value of this index can be reset to zero for each new pulse of the transmitted signal. In other words, this involves implementing temporal folding of a signal formed by the considered data. A third axis of the matrix can correspond to the value, denoted S, assumed by each sampled datum.

In sub-step (c23), this involves extracting, for each pulse of the transmitted signal, data relating to a portion of the return signal, for which portion the difference between the emission instant of the pulse of the transmitted signal and the reception instant of said portion of the corresponding pulse of the return signal is less than the threshold, denoted T1.

The threshold T1 defines a predetermined detection zone that extends, from the transmission and reception zone of the signal, up to a maximum distance D1 to the latter, with D1=c*T1/2, where c is the speed of light in a vacuum.

Such an extraction sub-step can be easily seen when the sampled data I(tᵢ) and Q(tᵢ) is depicted in the form of matrices.

If applicable, it is possible to extract, in step (c23), the data only relating to portions of the return signal, for which a time difference ΔT between the reception of said signal portion and the emission of a corresponding pulse of the transmitted signal is both less than the threshold T1 and greater than a second threshold T2, less than T1. The predetermined detection zone can then extend between two concentric disks with a radius of D1=c*T1/2 and D2=c*T2/2, respectively. It is possible to select T2=1 as a unit of “tap num” (for example, 1 ns), in order to overcome the effect of internal reflections within the transmission and/or reception device.

In any case, this extraction sub-step allows only signal portions associated with a reflection on a target located in said predetermined detection zone to be considered, and avoids the effect of reflection on irrelevant targets because they are located outside said detection zone.

The predetermined detection zone can correspond to a zone in which the movement intended to control the opening of the opening generally occurs. This predetermined detection zone may not extend beyond a distance D1=60 cm, which corresponds to T1=4 ns, that is, a “tap num” index equal to 4 on the aforementioned matrix.

Sub-steps (c25) and (c26) aim to follow, on said extracted data, the return signal that has been reflected on the target, in order to deduce the movement of said target therefrom.

Indeed, as the phase of the return signal represents a position of the target, the evolution of the phase indicates a variation in the position of the target, and therefore a movement of the target. Thus, the evolution of this phase value allows a movement performed by the target to be characterized.

The monitoring of the phase values can take into account the fact that, each time the distance covered by the radiofrequency wave varies by λ (where λ is the central wavelength of the carrier of said radiofrequency signal), this phase value varies by 2π.

This monitoring can also take into account a possible change in the time difference between the peak considered on the return signal and the emission instant of the corresponding pulse of the transmitted signal (in other words, a change in the “tap num” index of the considered peak).

According to yet other variants, step (c) implements Doppler frequency computations, based on, for example, the use of a Fast Fourier Transform (FFT). The FFT allows the frequencies of the return signal to be obtained, if a difference exists between the frequency f of the emitted carrier, and the received frequency, this is due to the Doppler effect. The radial speed of said target is deduced from this difference. By integrating this speed over time, the distance of the radial movement of said target is deduced therefrom.

Advantageously, the position of the target is not defined solely in terms of the distance to the zone receiving the transmitter and the receiver, but also in terms of the angle of incidence on the receiver. This allows movement speed and linear amplitude of movement values to be more precisely determined, when the angle of incidence significantly varies during this movement. Furthermore, this allows an angular amplitude of movement to be determined when necessary. The method then uses at least two associated receivers, which are spaced apart from each other by a known distance. Step (c) of the method can then comprise a step of determining a time shift between the arrival instant of a portion of the return signal on a first receiver and the arrival instant of an equivalent portion of the return signal on a second receiver, with this time shift allowing a distance D to be determined, which in turn allows the angle of incidence θ of a beam of parallel rays on the first and second receivers to be determined. The angle θ is formed between the axis connecting the target with a first receiver, and the axis connecting the first receiver with a second receiver. A first transmitter, associated with the first receiver, can be located in the same zone as the first receiver. Similarly, a second transmitter, associated with the second receiver, can be located in the same zone as the second receiver. As a variant, each receiver is a transceiver. According to yet more variants, a single transmitter extends close to the first and second receivers. According to another variant, a transceiver is associated with a single receiver.

In particular, considering a right-angled triangle, two vertices of which are formed by the first and second receivers, and the third vertex of which has a right angle and is opposite the side of the triangle connecting the two receivers.

Let d be the length of the side of the triangle connecting the two receivers and let D be the length of the side of the triangle connecting one of the two receivers to the vertex with a right angle.

Assuming the target is far enough away from the distance between the two receivers, it is possible to consider that the return signals arrive at the same angle of incidence θ on each of the two receivers.

Then:
D=c·ΔT, where c is the speed of light and where ΔT is the difference between the reception instants of the signal received between the two receivers, ΔT also can be computed from the phase difference between the two receivers: ΔT=Δφ/(2πf), with f being the carrier frequency;

$$cos θ = D / d and thus θ = cos - 1 ( D / d ) .$$

A position, a speed, a movement amplitude and/or a trajectory of the target relative to the vehicle thus can be computed based on the evolution of the distance between the target and the emission and/or reception zone (measured using the time of flight and/or the evolution of the phase and/or via Doppler frequency measurements), and, if applicable, also using the evolution of the angle θ, over time.

The present document also relates to a computer program comprising instructions which, when the program is executed by at least one processor, cause the computer to implement all the steps of a method as described above.

The present document also relates to a computer comprising at least one processor and at least one memory and intended to be installed in a motor vehicle, characterized in that it is configured for implementing each of the steps of a method as described above.

The present document also relates to a system for managing the opening of an opening intended to be installed in a motor vehicle, characterized in that it comprises:
at least one antenna intended to transmit the transmitted signal (radiofrequency signal, preferably of the pulse type) and to receive the return signal (radiofrequency signal, preferably of the pulse type); and
an electronic management module comprising a computer as previously described.

The present document also relates to a motor vehicle provided with a movable opening, able to be moved by an actuator between a fully open position, a fully closed position and at least one partially open intermediate position, characterized in that it comprises a system for managing the opening of said opening as previously described.

### BRIEF DESCRIPTION OF THE DRAWINGS

Further features, details and advantages will become apparent upon reading the following detailed description, and with reference to the appended drawings, in which:

FIG. 1 is a schematic view of a motor vehicle according to the present document;

FIG. 2 illustrates the various steps of the method according to the present document;

FIG. 3 illustrates a matrix consolidating values of a plurality of pulses;

FIG. 4 schematically illustrates a step of determining an angle θ formed between the axis connecting the target with a first receiver and the axis connecting the first receiver with a second receiver.

### DETAILED DESCRIPTION OF AT LEAST ONE EMBODIMENT

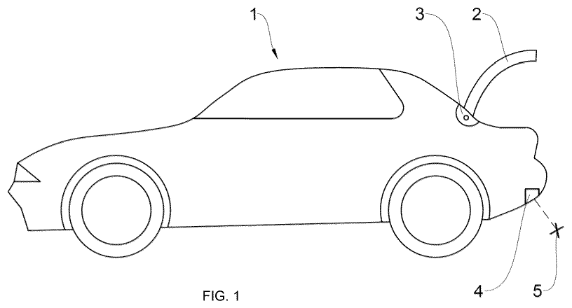

FIG. 1 schematically shows a motor vehicle 1 comprising a movable opening 2, able to be moved by an actuator 3 between a fully open position, a fully closed position and at least one partially open intermediate position, with the vehicle comprising a system for managing the opening of said opening 2.

Said management system comprises:
at least one antenna 4 intended to transmit and receive a pulse radiofrequency signal; and
an electronic management module comprising a computer.

The computer comprises a processor and at least one memory, and is configured to implement each of the steps of a method for managing the opening of the opening 2 described hereafter.

The computer is able to generate an output signal for controlling the actuator 3.

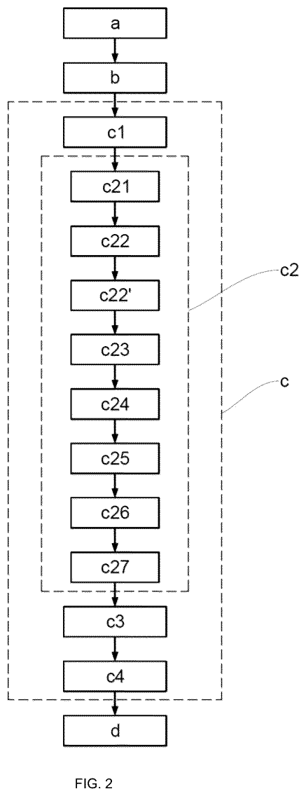

The method for managing the opening of the opening 2 is described hereafter with reference to FIG. 2.

This method allows said opening 2 to be controlled by detecting a movement of a target 5, such as a hand or a foot of a user.

This method comprises the successive steps described hereafter.

During a step (a), a signal is transmitted, using the antenna, with this signal being intended to interact with the target. This signal is an ultra-wide band pulse signal comprising a carrier modulated by a sequence of pulses and characterized by very short pulses over time (for example, of the order of a few nanoseconds) and a very wide bandwidth (for example, greater than 500 MHz, or even more than 1 GHz).

During a step (b), the signal reflected on the target is returned and picked up by the antenna, with this signal being called return signal.

During a step (c) at least one characteristic is determined, based on the transmitted signal and the return signal, from among a movement speed, a linear amplitude of movement, and/or an angular amplitude of movement, relating to a movement of the target 5 relative to a determined zone of the vehicle.

Optionally, during a sub-step (c1), an approximate distance to the target is determined, implementing measurement of a time shift between a pulse of the return pulse signal and the corresponding pulse of the transmitted pulse signal.

This sub-step (c1) particularly implements the measurement of a time of flight, i.e., the measurement of a time taken by a pulse to complete the round trip between the antenna and the target, as indicated above.

Then, during a sub-step (c2), an additional distance to the target is determined, implementing monitoring of phase shift values between the return pulse signal and the transmitted pulse signal. In an advantageous variant, only this additional distance to the target is computed, with the relevant information relating to a movement, and therefore to variations in position.

For this computation of the additional distance to the target, the following is generated, during a sub-step (c21):
a signal I(t) relating to an in-phase component of the return signal by in-phase mixing between the return signal and a signal at the frequency of the transmitted signal; and
a signal Q(t) relating to a phase-quadrature component of the return signal by phase-quadrature mixing between the return signal and a signal at the frequency of the transmitted signal.

This amounts to demodulating the return signal.

Then, during a sub-step (c22), sampled data I(tᵢ) and Q(tᵢ) is obtained corresponding to temporal sampling of the signals I(t) and Q(t). Sub-step (c22) can be implemented using an analog-to-digital converter. This temporal sampling can be implemented downstream of the generation of the signals I(t) and Q(t). The sampling pitch can range between 0.8 ns and 2 ns, for example, can be equal to 1 ns.

Said method can then comprise an optional step (c22′) of constructing matrices.

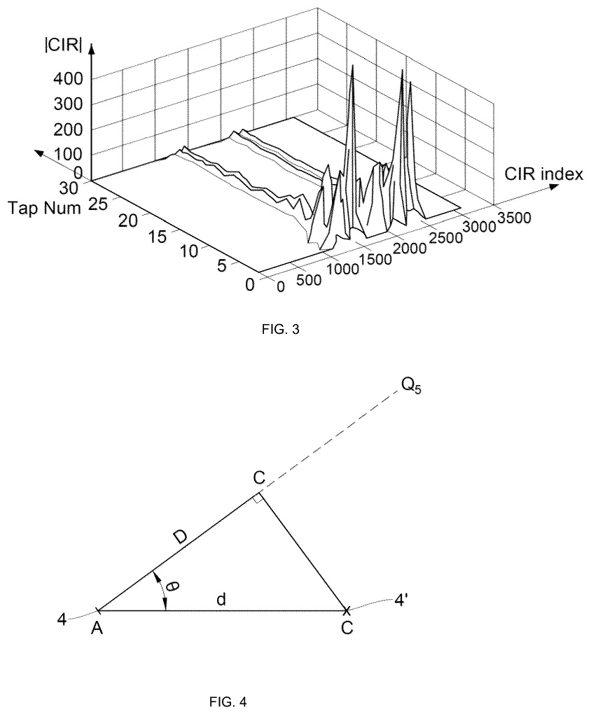

In this sub-step (c22′), the sampled data I(tᵢ) and Q(tᵢ) can be rows in the form of matrices, as illustrated in FIG. 3. A first axis of the matrix, denoted “CIR index”, can correspond to a pulse index of the transmitted signal. A second axis of the matrix can correspond to an index, denoted “tap num”, of a sampling instant. The value of this index can be reset to zero for each new pulse of the transmitted signal. In other words, this involves implementing temporal folding of a signal formed by the considered data. A third axis of the matrix can correspond to the value, denoted S, assumed by each sampled datum.

Then, during a sub-step (c23) and from the sampled data I(tᵢ) and Q(tᵢ), any data is extracted that only relates to portions of the return signal, for which a time difference between the reception of said portion of the return signal and the emission of a corresponding pulse of the transmitted signal is less than or equal to a threshold.

In this sub-step (c23), this involves extracting, for each pulse of the transmitted signal, data relating to a portion of the pulse corresponding to the transmitted signal, for which portion the difference between the emission instant of the pulse of the transmitted signal and the reception instant of said portion of the corresponding pulse of the return signal is less than the threshold, denoted T1.

The threshold T1 defines a predetermined detection zone that extends, from the transmission and reception zone of the signal, up to a maximum distance D1 to the latter, with D1=c*T1/2, where c is the speed of light in a vacuum.

Such an extraction sub-step can be easily seen when the sampled data I(tᵢ) and Q(tᵢ) is depicted in the form of matrices.

If applicable, it is possible to extract the data only relating to portions of the return signal, for which a time difference ΔT between the reception of said signal portion and the emission of a corresponding pulse of the transmitted signal is both less than the threshold T1 and greater than a second threshold T2, less than T1. The predetermined detection zone can then extend between two concentric disks with a radius of D1=c*T1/2 and D2=c*T2/2, respectively. It is possible to select T2=1 as a unit of “tap num” (for example, 1 ns), in order to avoid the effect of internal reflections within the transmission and/or reception device.

In any case, this extraction sub-step allows only signal portions associated with a reflection on a target located in said predetermined detection zone to be considered, and avoids the effect of reflection on irrelevant targets because they are located outside said detection zone.

The predetermined detection zone can correspond to a zone in which the movement intended to control the opening of the opening 2 generally occurs. This predetermined detection zone may not extend beyond a distance D1=60 cm, which corresponds to T1=4 ns, or a “tap num” index equal to 4 on the aforementioned matrix.

Then, during a sub-step (c24), for each sampling instant tᵢ, a modulus of the extracted data I(tᵢ) and Q(tᵢ) is computed, denoted |CIR(tᵢ)|, corresponding to the amplitude of the demodulated return signal, and having a value equal to the square root of I²(tᵢ)+Q²(tᵢ).

During a sub-step (c25), the computed data |CIR(tᵢ)| is searched, successively for each pulse of the transmitted signal, for the presence of a peak with an amplitude that is greater than or equal to a predetermined threshold, with such a peak corresponding to the identification of the beginning of a gesture, with the instant tⱼ associated with such a peak being recorded and a pulse of index k of the transmitted signal being associated with said peak.

Then, during a sub-step (c26), the phase φ(k) of the demodulated return signal is computed using the values I and Q associated with said instant tⱼ of the peak, using the following formulae:

$$if I ( {t}_{j} ) > 0 , then φ ( k ) = arctan ( Q ( {t}_{j} ) / I ( {t}_{j} ) ) ; \\ if I ( {t}_{j} ) < 0 and if Q ( {t}_{j} ) < 0 , then φ ( k ) = arctan ( Q ( {t}_{j} ) / I ( {t}_{j} ) ) - π ; \\ if I ( {t}_{j} ) < 0 and if Q ( {t}_{j} ) > 0 , then φ ( k ) = arctan ( Q ( {t}_{j} ) / I ( {t}_{j} ) ) + π .$$

The evolution of the value of the phase φ is then computed, during a sub-step (c27), for the following pulses k+n of the emitted signal.

Sub-steps (c25) and (c26) aim to follow, on said extracted data, the phase of the return signal that has been reflected on the target, in order to deduce the movement of said target therefrom.

Indeed, as the phase represents a position of the target, the evolution of the phase indicates a variation in the position of the target, and therefore a movement of the target. Thus, the evolution of this phase value allows a movement performed by the target to be characterized.

The monitoring of the phase values can take into account the fact that, each time the distance covered by the radiofrequency wave varies by λ (where λ is the central wavelength of the carrier of said radiofrequency signal), this phase value varies by 2π.

This monitoring can also take into account a possible change in the time difference between the peak considered on the return signal and the emission instant of the corresponding pulse of the transmitted signal (in other words, a change in the “tap num” index of the considered peak).

Then, during a sub-step (c3) (optional), the approximate distance to the target and the additional distance to the target are combined, so as to obtain an estimated value of the distance to the target.

Then, during a sub-step (c4), said sub-steps (c1) to (c3) (or as a variant step (c2) alone) are repeated, so as to obtain a time series of estimated values of the distance to the target, with said time series of values defining a gesture.

In the case whereby the method implements at least two antennas 4, 4′, (FIG. 4) spaced apart from one another, then step (c) of the method can also comprise a step of determining an angle θ formed between the axis connecting the target 5 with a first antenna 4 and the axis connecting the first antenna 4 with the second antenna 4′.

Considering a right-angled triangle, two vertices A and B of which are formed by the first and second antennas 4, 4′, and the third vertex C of which has a right angle and is opposite the side AB of the triangle connecting the two antennas 4, 4′.

Let d be the length of the side AB of the triangle connecting the two antennas 4, 4′ and let D be the length of the side AC of the triangle connecting one of the two antennas 4 to the vertex C.

Assuming the target 5 is far enough away from the distance d between the two antennas 4, 4′, it is possible to consider that the return signals arrive at the same angle θ on each of the two antennas 4, 4′.

Then:
D=c·ΔT, where c is the speed of light and where ΔT is the difference between the reception instants of the return signal by each of the respective two antennas 4, 4′, ΔT also can be computed from the phase difference between the two receivers: ΔT=Δφ/(2πf), with f being the carrier frequency;

$$cos θ = D / d and thus θ = cos - 1 ( D / d ) .$$

The movement speed and the linear amplitude of movement of the target 5 relative to the vehicle can be computed both based on the evolution of the distance between the target and the emission and/or reception zone (measured, for example, using the time of flight and/or the evolution of the phase), and based on the evolution of the angle θ, over time. The computation of an angular amplitude of movement of the target uses said evolution of the angle θ, over time.

As a variant, the method can implement at least three antennas, for example, three antennas, not aligned on the same axis or on the same plane. The use of three non-coplanar antennas allows the position of a target to be determined in all the directions of space, i.e., in three dimensions. This notably means that it is possible to detect complex positions, trajectories, movements or gestures of the target, in particular gestures that are not only contained in a single plane. Such complex gestures notably can involve a rotation of the wrist or a rotation of the arm when the target is a hand of a user.

Finally, during a step (d), the degree of opening of the opening 2 is controlled using the actuator 3, as a function of the linear amplitude of movement and/or, if applicable, the angular amplitude of movement of the target 5. In addition or as a variant, the opening speed of the opening 2 is controlled using the actuator 3, as a function of the movement speed of the target 5.

It will be understood that, in order to implement this command, the method implements a comparison between:
at least one current measured value of a movement speed and/or a linear amplitude of movement and/or an angular amplitude of movement, on the one hand; and
calibration data for connecting said current measured value with an opening speed, respectively a degree of opening.

The calibration can simply originate from adjustments, called “factory” adjustments, or even also to self-adaptation to the average gestures of the user.

This calibration data is stored in a memory of a computer intended to be installed in the vehicle 1, with this computer comprising at least said memory and at least one processor, and being configured to implement the steps of the method described above.

In the description of the figures, the case whereby the characteristics relating to the movement of the target are obtained by monitoring phase values has been described more specifically. An aspect of invention is not limited to this solution, and will be able to implement well-known variants, based, for example, on an extraction of the Doppler frequency. Indeed, the Doppler effect on the frequency of the return signal provides information concerning the radial speed of the target. By applying the matrices I(ti) and Q(ti) to the data, a Fast Fourier Transform (FFT) allows the frequencies of the return signal to be obtained. The difference that exists between the frequency of the emitted carrier f and the received frequency is the Doppler frequency Δf. The radial speed of the target is deduced by: V=c*Δf/f, where c is the speed of light in a vacuum, and f is the frequency of the carrier of the transmitted signal. By integrating this speed over time, the distance of the radial movement of said target is deduced therefrom.

1. A method for controlling an opening of a motor vehicle by detecting a movement of a target, such as a hand or a foot of a user, said opening being able to be moved by an actuator so as to be able to control its opening speed, and/or its degree of opening between a fully open position, a fully closed position and at least one partially open intermediate position, said method comprising:
(a) transmitting, using at least one transmitter, a radiofrequency signal, called transmitted signal, intended to at least partially reflect on said target;
(b) receiving, using at least one receiver, a radiofrequency signal, called return signal, originating from the reflection of the transmitted signal on said target;
(c) determining, based on the transmitted signal and the return signal, at least one characteristic from among a movement speed, a linear amplitude of movement, and/or an angular amplitude of movement, relating to a movement of the target relative to a determined zone of the vehicle;
(d) controlling the degree of opening and/or the opening speed of the opening, using the actuator, and as a function of said characteristic relating to the movement of the target;
the method implementing a comparison between:
said at least one characteristic from among a movement speed, a linear amplitude of movement and/or an angular amplitude of movement, on the one hand; and
calibration data for connecting said characteristic with an opening speed, respectively a degree of opening;
such that:
a high value of the linear amplitude of movement and/or of the angular amplitude of movement allows significant movement of the opening, and vice versa; and
a fast movement speed allows fast movement of the opening, and vice versa.

2. The method as claimed in claim 1, wherein the opening is able to be pivoted or translated between its fully open position, its fully closed position and at least one intermediate position:
step (c) includes determining the linear amplitude of movement of the target; and
step (d) includes controlling the degree of opening of the opening as a function of the linear amplitude of movement of the target.

3. The method as claimed in claim 1, wherein:
step (c) includes determining the movement speed of the target; and
step (d) includes controlling the opening speed of the opening as a function of the movement speed of the target.

4. The method as claimed in claim 1, wherein the opening is able to be pivoted between its fully open position, its fully closed position and at least one intermediate position, and:
step (c) includes determining an angular amplitude of movement of the target; and
step (d) includes controlling an angular degree of opening of the opening as a function of the angular amplitude of movement of the target.

5. The method as claimed in claim 1, wherein the transmitted signal is a pulse signal comprising a carrier modulated by a sequence of pulses.

6. The method as claimed in claim 5, wherein the signal is an ultra-wideband signal.

7. The method as claimed in claim 5, wherein step (c) comprises the following sub-steps of:
(c21) generating a signal I(t) relating to an in-phase component of the return signal, by mixing between the return signal and an in-phase signal and at the frequency of the transmitted signal, and a signal Q(t) relating to a quadrature-phase component of the return signal, by mixing between the return signal and a quadrature-phase signal and at the frequency of the transmitted signal, with the signals I(t) and Q(t) defining the two components of a demodulated return signal;
(c22) obtaining sampled data I(tᵢ) and Q(tᵢ) corresponding to temporal sampling of the signals I(t) and Q(t);
(c23) extracting, in the sampled data I(tᵢ) and Q(tᵢ), any data only relating to portions of the return signal, for which a time difference between the reception of each portion of the return signal and the emission of a corresponding pulse of the transmitted signal is less than or equal to one or more thresholds;
(c24) computing, for each sampling instant ti, a modulus of the extracted data I(tᵢ) and Q(tᵢ), denoted |CIR(tᵢ)|, corresponding to the amplitude of the demodulated return signal, and having a value equal to the square root of I²(tᵢ)+Q²(tᵢ);
(c25) searching, in the computed data |CIR(tᵢ)|, and successively for each pulse of the transmitted signal, for the presence of a peak with an amplitude that is greater than or equal to a predetermined threshold, with the first detection of such a peak corresponding to the identification of the beginning of a movement of the target, the instant tⱼ associated with such a peak being recorded and a pulse of index k of the transmitted signal being associated with the first detection of such a peak;
(c26) computing the phase φ(k) of the demodulated return signal using the values I and Q associated with said instant tⱼ of the peak, using the following formulae:
$$[ [ - ] ] if I ( {t}_{j} ) > 0 , then φ ( k ) = arctan ( Q ( {t}_{j} ) / I ( {t}_{j} ) ) ; \\ [ [ - ] ] if I ( {t}_{j} ) < 0 and if Q ( {t}_{j} ) < 0 , then φ ( k ) = arctan ( Q ( {t}_{j} ) / I ( {t}_{j} ) ) - π ; \\ [ [ - ] ] if I ( {t}_{j} ) < 0 and if Q ( {t}_{j} ) > 0 , then φ ( k ) = arctan ( Q ( {t}_{j} ) / I ( {t}_{j} ) ) + π .$$
(c27) computing the evolution of the value of the phase φ, for the subsequent k+n pulses of the transmitted signal.

8. A computer comprising at least one processor and at least one memory and intended to be installed in a motor vehicle, characterized in that it is configured for implementing each of the steps of a method as claimed in claim 1.

9. A system for managing the opening of an opening intended to be installed in a motor vehicle, the system comprising:
at least one antenna intended to transmit the transmitted signal and to receive the return signal; and
an electronic management module comprising a computer as claimed in claim 8.

10. A motor vehicle provided with a movable opening, able to be moved by an actuator between a fully open position, a fully closed position and at least one partially open intermediate position, comprising a system for managing the opening of said opening as claimed in claim 9.

11. The method as claimed in claim 2, wherein:
step (c) includes determining the movement speed of the target; and
step (d) includes controlling the opening speed of the opening as a function of the movement speed of the target.

12. The method as claimed in claim 6, wherein step (c) comprises the following sub-steps of:
(c21) generating a signal I(t) relating to an in-phase component of the return signal, by mixing between the return signal and an in-phase signal and at the frequency of the transmitted signal, and a signal Q(t) relating to a quadrature-phase component of the return signal, by mixing between the return signal and a quadrature-phase signal and at the frequency of the transmitted signal, with the signals I(t) and Q(t) defining the two components of a demodulated return signal;
(c22) obtaining sampled data I(tᵢ) and Q(tᵢ) corresponding to temporal sampling of the signals I(t) and Q(t);
(c23) extracting, in the sampled data I(tᵢ) and Q(tᵢ), any data only relating to portions of the return signal, for which a time difference between the reception of each portion of the return signal and the emission of a corresponding pulse of the transmitted signal is less than or equal to one or more thresholds;
(c24) computing, for each sampling instant ti, a modulus of the extracted data I(tᵢ) and Q(tᵢ), denoted |CIR(tᵢ)|, corresponding to the amplitude of the demodulated return signal, and having a value equal to the square root of I²(tᵢ)+Q²(tᵢ);
(c25) searching, in the computed data |CIR(tᵢ)|, and successively for each pulse of the transmitted signal, for the presence of a peak with an amplitude that is greater than or equal to a predetermined threshold, with the first detection of such a peak corresponding to the identification of the beginning of a movement of the target, the instant tⱼ associated with such a peak being recorded and a pulse of index k of the transmitted signal being associated with the first detection of such a peak;
(c26) computing the phase φ(k) of the demodulated return signal using the values I and Q associated with said instant tⱼ of the peak, using the following formulae:
$$if I ( {t}_{j} ) > 0 , then φ ( k ) = arctan ( Q ( {t}_{j} ) / I ( {t}_{j} ) ) ; \\ if I ( {t}_{j} ) < 0 and if Q ( {t}_{j} ) < 0 , then φ ( k ) = arctan ( Q ( {t}_{j} ) / I ( {t}_{j} ) ) - π ; \\ if I ( {t}_{j} ) < 0 and if Q ( {t}_{j} ) > 0 , then φ ( k ) = arctan ( Q ( {t}_{j} ) / I ( {t}_{j} ) ) + π .$$
(c27) computing the evolution of the value of the phase φ, for the subsequent k+n pulses of the transmitted signal.
